(19) United States
(12) Patent Application Publication
(10) Pub. No.: US 2008/0174745 A1
(43) Pub. Date: Jul. 24, 2008

(54) Digital light projector with improved contrast

(75) Inventor: Blaise Rene Joseph Robitaille, Penetanguishene (CA)

Correspondence Address: Benman, Brown & Williams, Suite 2740, 2049 Century Park East, Los Angeles, CA, 90067, US

(73) Assignee: Raytheon Company

(21) Appl. No.: 11/655,564

(22) Filed: Jan. 18, 2007

(51) Int. Cl. G03B 21/28

(52) U.S. Cl. 353/85

(57) ABSTRACT

A system and method for projecting light including an arrangement for illuminating an array of digital micro-mirror devices with light; projecting light reflected by the array elements in an ‘on’ state thereof; and trapping light reflected by the array elements in an ‘off’ state thereof. The light trap is implemented with an anodized metal foam matrix. The matrix is secured relative to the array. The invention may be used in a variety of applications. In a digital light projector, a light source is included along with a prism and a projection lens. The metal foam matrix acts not only as a light trap but also as a heat-sink.

### BACKGROUND OF THE INVENTION

1. Field of the Invention

The present invention relates to optics and optical systems. More specifically, the present invention relates to digital micro-mirror devices, digital light modulators, and methods and systems for projecting light using such devices.

2. Description of the Related Art

A Digital Micromirror Device (DMD) is an optical semiconductor that is the core of Digital Light Projection (DLP) projection technology. A DMD is a device which has an array of micro-mirrors monolithically integrated onto a memory chip. Often used in projectors, a DMD chip has on its surface several hundred thousand microscopic mirrors. The mirrors are typically arranged in a rectangular array in which each mirror element corresponds to a pixel in the image to be displayed. See Wikipedia at http://en.wikipedia.org/wiki/Digital_Micromirror Device as of Oct. 30, 2006.

The mirrors are individually tilted ±10-12°, to an ‘on’ or ‘off’ state through an electrostatic attraction. In the ‘on’ state, light from a source is reflected into the lens making the pixel appear bright on the screen. (See U.S. Pat. No. 6,997,564 issued Feb. 14, 2006 to B. Robitaille and entitled DIGITAL PROJECTION

In the ‘off’ state, the light is directed elsewhere (usually onto a heatsink), making the pixel appear dark. However, during the off-state condition, it is often difficult to prevent the off-state light from re-entering the exit pupil of the projection lens due to retro-reflections, which in turn adversely affects the optical performance of the system. Off-state light is typically allowed to exit the projector assembly freely onto a darkened surface of the subassembly or a heat sink or an adjacent surface inside the device. These surfaces are typically either painted with a light absorbing black paint or simply anodized black. With higher intensity displays, simply dumping the light into the unit may not be an option and light-absorbing paint may not withstand elevated temperatures, therefore limiting options.

Hence, a need remains in the art for a system or method for disposing of light energy, particularly off-state light in DMD/DLP projectors and displays.

### SUMMARY OF THE INVENTION

The need in the art is addressed by the system and method for projecting light of the present invention. The inventive system provides an arrangement for illuminating an array of digital micro-mirror devices with light; projecting light reflected by the array elements in an ‘on’ state thereof; and trapping light reflected by the array elements in an ‘off’ state thereof.

In more specific embodiments, the invention includes a light trap implemented with an anodized metal foam matrix. The matrix is secured relative to the array with a bonding agent, clip or other mechanism. The invention may be used in a variety of applications. In a digital light projector, a light source is included along with a prism and a projection lens. The metal foam matrix acts not only as a light trap but also as a heat sink.

### BRIEF DESCRIPTION OF THE DRAWINGS

FIG. 1 depicts a digital projection display according to an illustrative embodiment of the present teachings.

FIG. 2 is a simplified sectional side view of a portion of the projector of FIG. 1.

FIG. 3 is a diagram showing an illustrative embodiment of the optical light trap of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

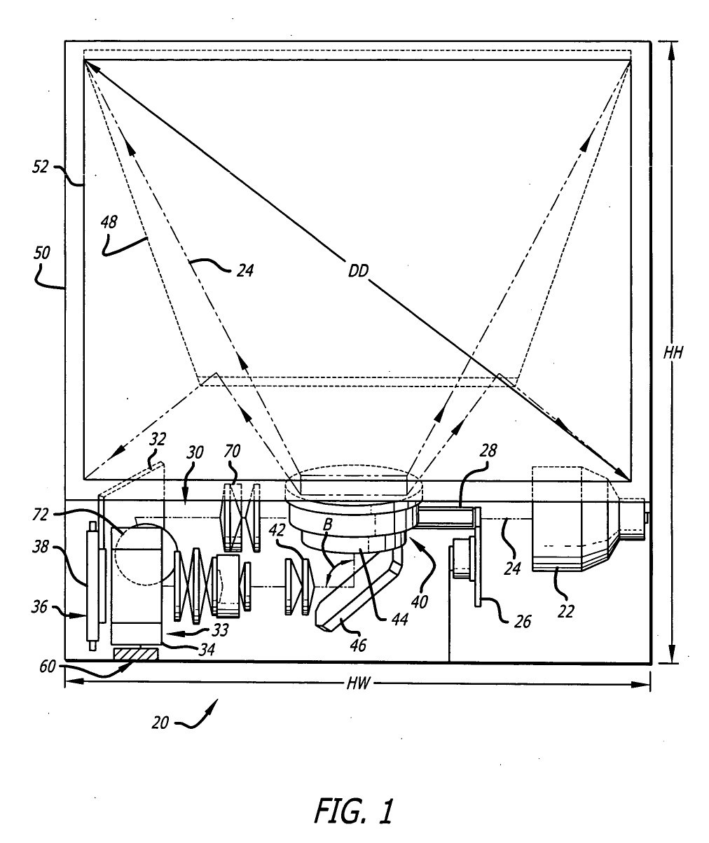

FIG. 1 depicts a digital projection display 20 according to an illustrative embodiment of the present teachings. This design is substantially similar to that of the above-referenced U.S. Pat. No. 6,997,564 issued Feb. 14, 2006 to B. Robitaille and entitled DIGITAL PROJECTION DISPLAY, the teachings of which are incorporated herein by reference. However, as discussed more fully below, a significant difference between the design of the referenced patent and the embodiment of FIG. 1 is the inclusion in FIG. 1 of an optical light trap 60 for minimizing the effects of ‘off’ state stray light on the contrast performance of the system.

The structure of the digital projection display 20 is most readily discussed in terms of the order of the components along the light path from the light source to the display screen.

The digital projection display 20 includes a light source 22 producing as an output a light beam 24. The light source 22 may be of any operable type, but is typically a polychromatic light source such as a compact arc lamp.

Optionally but preferably, a color wheel 26 having red, blue, and green segments receives the light beam 24 from the light source 22. The color wheel 26 spins in the light beam 24 so that the light beam 24 is sequentially colored with the primary red-blue-green colors that are combined to produce a full-color image after subsequent modulation. A white fourth segment may also be present. The color wheel 26 is not required if the projected image is to be a black-white image or if using a multi-color (e.g. a blue, red and green) LED light source.

An integrator 28 receives the light beam 24 from the color wheel 26 (or directly from the light source in the absence of the color wheel 26). The integrator 28 is preferably a solid transparent rod or a hollow pipe that provides multiple internal reflections of the light beam 24. The integrator has two effects. It makes the light beam 24 more uniform over its cross section and prevents the formation of an image of the filament of the light source 22. Second, the integrator 28 shapes the light beam 24 to have the desired peripheral shape of the final projected image. In the usual case, the final projected image is rectangular, so that the output of the integrator 28 is rectangular with an aspect ratio that matches that of the spatial light modulator. The integrator 28 does not spatially modulate the light beam 24.

An illumination lens 30 receives the light beam 24 from the integrator 28. The illumination lens 30 may include one lens element or more than one lens element. In the illustration, the illumination lens has two illumination lens elements 70 and 72. The illumination lens 30 images the exit end of the integrator 28 onto the digital light modulator to be discussed subsequently.

An illumination fold mirror 32 receives the light beam 24 from the illumination lens element 70 and reflects the light beam 24. The illumination fold mirror 32 changes the direction of the light beam 24. In combination with other fold mirrors in the digital projection display 20, the illumination fold mirror 32 allows the optics of the digital projection display 20 to fit within a compact envelope. In the preferred embodiment, the illumination fold mirror 32 reflects the light beam 24 through an angle A of about 80 degrees. After the light beam 24 reflects from the illumination fold mirror 32, it passes through the illumination lens element 72.

A light director 33, preferably a total internal reflection (TIR) prism 34, receives the light beam 24 from the illumination fold mirror 32. An internal reflective surface (not shown) of the TIR prism 34 is oriented such that the light beam 24 that enters the TIR prism 34 is totally reflected.

In an alternative approach, termed an offset approach, a lens directs the light beam 24 to and from the light modulator (discussed next), and there is no TIR prism. A digital light modulator 36 receives the light beam 24 from the light director 33 (which is preferably the TIR prism 34) and spatially modulates the light beam 24. The digital light modulator 36 receives image information in electronic form from an image source (not shown). The digital light modulator 36 then spatially modulates the light beam 24 with that electronic image information. The digital light modulator 36 is preferably a digital micromirror device 38. The digital micromirror device 38 is an array of movable small mirrors, each of which small mirrors serves as the modulator for one pixel of the resulting image. However, the present invention is not limited thereto. That is, the present teachings may be used in any system in which stray energy is problematic.

By controlling the orientations of the individual small mirrors, each pixel of the incident light beam 24 may be selectively reflected in the proper direction to eventually form part of the reflected image (an illuminated pixel), or selectively reflected in another direction so that it does not form part of the reflected image (a dark pixel). The result is that the light beam 24 is spatially modulated.

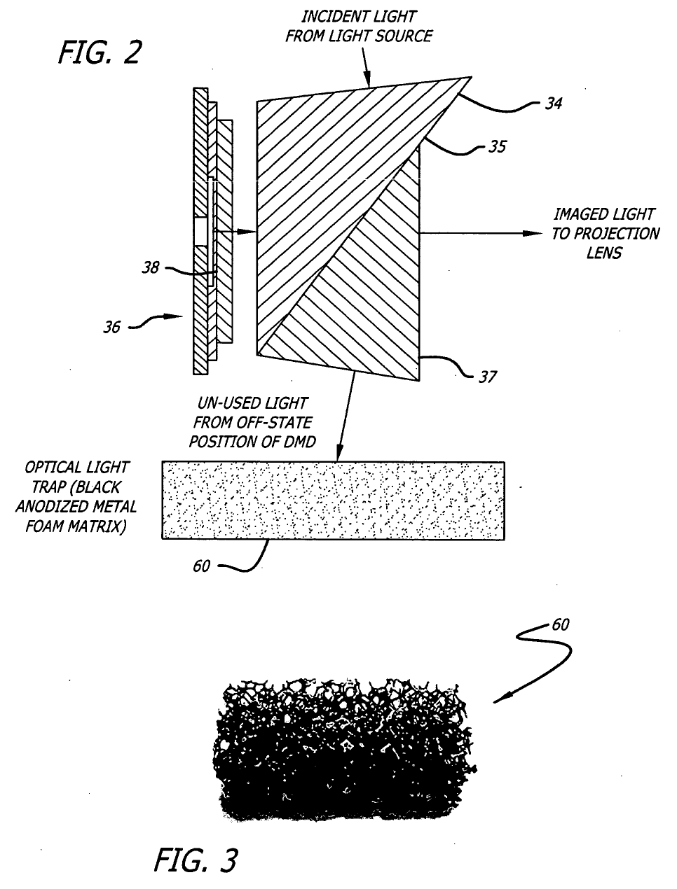

In the preferred embodiment wherein the light director 33 is the TIR prism 34, the light beam 24 is sent back to the TIR prism 34 in its spatially modulated form. The internal reflective surface of the TIR prism 34 is oriented such that the incident light beam 24 that is received back from the digital light modulator 36 is not reflected by the internal reflective surface and passes straight through the TIR prism 34. This is illustrated more clearly in FIG. 2.

FIG. 2 is a simplified sectional side view of a portion of the projector of FIG. 1. As shown in FIG. 2, light from the source 22 enters the prism 34 and reflects off the interface 35 thereof toward the DMD 38. In its ‘on’ state, each mirror in the DMD reflects light back to and through the prisms 34 and 37 to a projection lens 40 as discussed more fully below. ‘Off’ state light from mirror elements in the DMD in the ‘off’ states thereof fails to pass through the prisms 34 and 37. This light is reflected internally in the second prism 37 and exits the second prism 37 to the novel optical light trap 60 provided in accordance with the present teachings.

FIG. 3 is a diagram showing an illustrative embodiment of the optical light trap 60 of the present invention. In the illustrative embodiment, the light trap 60 is a metal (e.g. aluminum) foam matrix that is clipped, bonded or otherwise secured in place within the projector 20 of FIG. 1. The foam matrix may be purchased from a manufacturer such as ERG Materials & Aerospace as Duocel® foam metal. DUOCE® Metal Foam (aluminum) has a 3-dimensional skeletal structure, duodecahedronal-shaped cells connected by continuous metal ligaments which can be purchased in various porosities ranging from 5 to 40 pores per inch. In the best mode, the foam has a porosity on the higher end of the range, i.e., 40 pores per inch. The foam should be anodized to enhance the absorptive properties thereof. Those of ordinary skill in the art will arrive at a thickness to provide sufficient absorption for a given application.

Returning to FIG. 1, the projection lens 40 receives the light beam 24 in its spatially modulated form from the TIR prism 34 (or directly from the digital light modulator 36 in some embodiments). In the present design, the projection lens 40 has at least a first projection lens element 42, and a second projection lens element 44 that is spaced apart from the first projection lens element 42. Taken together, the lens elements of the projection lens 40 focus the light beam 24 onto the display screen that is viewed by the user of the digital projection display 20, as discussed subsequently. The throw ratio of the projection lens 40 is preferably about 1.1. The throw ratio is defined as the distance along the light path 24 from the display screen to the nodal point closest to the display screen, divided by the width of the display screen.

A projection lens fold mirror 46 is disposed between the first projection lens element 42 and the second projection lens element 44. The light beam 24 passes through the first projection lens element 42, reflects from the projection lens fold mirror 46, and passes through the second projection lens element 44. In the preferred embodiment, the projection lens fold mirror 46 reflects the light beam 24 through an angle B of about 90 degrees.

A projection fold mirror 48 receives the light beam 24 from the projection lens 40 (and specifically from the second projection lens element 44) and redirects the light beam to the display screen to be discussed subsequently. In the preferred embodiment, the projection fold mirror 48 reflects the light beam 24 through an angle C of about 72 degrees.

The digital projection display 20 preferably includes a housing 50 in which the light source 22, the color wheel 26, the integrator 28, the illumination lens 30, the illumination fold mirror 32, the light director 33, the digital light modulator 36, the projection lens 40, the projection lens fold mirror 46, and the projection fold mirror 48 are received. The housing 50 has a housing envelope depth HD, a housing envelope width HW, and a housing envelope height HH. A housing envelope volume V is the product HD times HW times HH, even though the housing 50 may not be a perfectly defined rectangular prism.

The digital projection display 20 preferably includes a display screen 52 that receives the light beam 24 from the projection fold mirror 48. The display screen 52 typically forms one face of the housing 50. The light beam 24 is desirably incident upon the display screen 52 substantially perpendicularly to the display screen 52. As a result, the display screen 52 need not be holographic in structure, with its associated high cost when produced in relatively small numbers, and the projected image on the display screen 52 is not distorted. The display screen 52 has a display screen (maximum) diagonal dimension DD. The display screen 52 is typically rectangular in shape, as illustrated, and the dimension DD is the diagonal dimension of the rectangular shape.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

Accordingly,

What is claimed is:

1. A system for projecting light including:
means for illuminating an array of digital micro-mirror devices with light;
means for projecting light reflected by said array elements in an ‘on’ state thereof; and
means for trapping light reflected by said array elements in an ‘off’ state thereof.

2. The invention of claim 1 wherein said means for trapping light is a light trap.

3. The invention of claim 2 wherein said light trap is a metal foam matrix.

4. The invention of claim 3 wherein said matrix is anodized.

5. An optical light trap comprising:
a metal foam matrix and
means for securing said matrix relative to a source of electromagnetic energy.

6. The invention of claim 5 wherein said matrix is anodized.

7. The invention of claim 6 wherein said matrix is anodized.

8. A digital light projector comprising:
a light source;
an array of digital micro-mirror devices in functional alignment with said source;
a projection lens in alignment with said array; and
an optical light trap mounted to receive energy from said array.

9. The invention of claim 8 wherein said light trap is a metal foam matrix.

10. The invention of claim 9 wherein said foam matrix is anodized.

11. The invention of claim 8 further including a prism for directing light from said source to said mirror.

12. A digital light projector comprising:
a source;
an array of reflective devices;
an arrangement for directing energy from said source to said array;
a projection lens adapted to receive and project energy from at least one element in said array in an ‘on’ state thereof; and
an optical light trap disposed relative to said array to trap energy from said element in an ‘off’ state thereof.

13. The invention of claim 12 wherein said light trap is a metal foam matrix.

14. The invention of claim 13 wherein said foam matrix is anodized.

15. The invention of claim 12 wherein said arrangement further includes a prism for directing light from said source to said mirror.

16. A method for projecting light including the steps of:
illuminating an array of digital micro-mirror devices with light from a source;
projecting light reflected by said array elements in an ‘on’ state thereof; and
trapping light reflected by said array elements in an ‘off’ state thereof in a light trap.

17. The invention of claim 16 wherein said light trap is a metal foam matrix.

18. The invention of claim 17 wherein said matrix is anodized.
